(19) United States
(12) Patent Application Publication
(10) Pub. No.: US 2025/0383143 A1
(43) Pub. Date: Dec. 18, 2025

(54) Processing Gases

(71) Applicant: NET Power LLC, Durham, NC (US)

(72) Inventors: Xijia Lu, Durham, NC (US); Shima Masoumi, Durham, NC (US); Scott Thomas Martin, Durham, NC (US)

(73) Assignee: NET Power LLC, Durham, NC (US)

(21) Appl. No.: 19/235,971

(22) Filed: Jun. 12, 2025

Related U.S. Application Data
(60) Provisional application No. 63/660,222, filed on Jun. 14, 2024.

(51) Int. Cl. F25J 3/04; F02C 3/34

(52) U.S. Cl. CPC F25J 3/04018; F02C 3/34; F25J 3/04533; F25J 3/04618; F25J 2240/70; F25J 2260/80

(57) ABSTRACT

Systems and methods for processing gases are disclosed. A first cryogenic fluid stream is cryogenically separated from an air stream through an O₂ production system. A first cryogenic column in a CO₂ production system transfers heat to a first portion of the first cryogenic fluid stream. The CO₂ production system separates carbon dioxide from a combustion product stream. A second cryogenic column in an N₂ rejection system transfers heat to a second portion of the first cryogenic fluid stream. The N₂ rejection system separates a second cryogenic fluid stream from a combustible carbonaceous gas fuel stream. The air stream transfers heat to a first portion of the second cryogenic fluid stream.

### CROSS-REFERENCE TO RELATED APPLICATIONS

This application claims the benefit of U.S. Provisional Patent Application No. 63/660,222, filed Jun. 14, 2024 and entitled “Processing Gases,” the entire contents of which are incorporated by reference herein.

### TECHNICAL FIELD

The present disclosure relates to systems and methods for processing gases, for example in oxy-fuel combustion systems.

### BACKGROUND

Combustion systems, including the Allam Cycle, may utilize a carbonaceous fuel, an oxidant stream, and a recycled carbon dioxide stream to produce energy. The oxidant and recycle streams require energy inputs to produce. For certain details of the Allam Cycle, see U.S. Pat. No. 8,596,075, the entire contents of which are incorporated by reference herein.

### SUMMARY

In some examples, the disclosure provides a system for processing gases. The system includes an O₂ production system that cryogenically separates a first cryogenic fluid stream from an air stream. The system also includes a CO₂ production system that includes a first cryogenic column that cryogenically separates carbon dioxide from a combustion product stream. The first cryogenic column heats a first portion of the first cryogenic fluid stream. The system also includes an N₂ rejection system that includes a second cryogenic column that cryogenically separates a second cryogenic fluid stream from a combustible carbonaceous gas fuel stream. The second cryogenic column heats a second portion of the first cryogenic fluid stream. The O₂ production system further cools the air stream using a first portion of the second cryogenic fluid stream.

In some examples, the system further includes a power plant that employs an oxy-fuel combustor for driving a turbine using a mixture of a purified natural gas stream produced by the N₂ rejection system from the combustible carbonaceous gas fuel stream, a purified O₂ stream produced by the O₂ production system, and a CO₂ working fluid.

In some examples, the CO₂ working fluid is transcritical and is a recycle carbon dioxide working fluid stream. In some examples, the system includes an oxy-fuel combustor that generates the combustion product stream.

In some examples, the first cryogenic column receives a second portion of the second cryogenic fluid stream, the first cryogenic column heating the second portion of the second cryogenic fluid stream.

In some examples, the system further includes an adsorber unit and piping to pass the second portion of the second cryogenic fluid stream from the first cryogenic column to the adsorber unit, the second portion of the second cryogenic fluid stream cooling the adsorber unit to an operating temperature.

In some examples, the first cryogenic fluid stream is selected from the group consisting of nitrogen, oxygen, argon, helium, and carbon dioxide. In some examples, the second cryogenic fluid stream is selected from the group consisting of natural gas, methane, nitrogen, carbon dioxide, light hydrocarbons, and argon.

In some examples, the first cryogenic fluid stream is nitrogen and the O₂ production system further produces a third cryogenic fluid stream including oxygen.

In some examples, the combustion product stream is produced by an oxy-fuel combustor system by combusting a purified natural gas stream from the N₂ rejection system with an oxygen gas stream from the O₂ production system with a recycle carbon dioxide working stream from the oxy-fuel combustor system.

In some examples, the combustible carbonaceous gas fuel stream is selected from the group consisting of natural gas, methane, synthetic gas, gasified coal, gasified biomass, and other light hydrocarbons.

In some examples, the O₂ production system includes a direct contact water chiller to cool the air stream, and the direct contact water chiller is cooled by a second portion of the second cryogenic fluid stream.

In some examples, the O₂ production system includes a heat exchanger to cool the air stream using a second portion of the second cryogenic fluid stream.

In some examples, the O₂ production system cools the air stream using a third portion of the first cryogenic fluid stream.

In some examples, the air stream is at ambient conditions.

In some examples, the O₂ production system further produces a regen gas stream. The system further may include a heater to heat the regen gas stream. The CO₂ production system may include an adsorber unit through which the heated regen gas stream passes to regenerate the adsorber unit by heating the adsorber unit and by stripping water from the adsorber unit.

In some examples, the heater heats the regen gas stream using heat generated through combustion, heat generated by electric energy, a first heat exchanger to transfer heat from a turbine exhaust stream to the regen gas stream, the turbine exhaust stream produced in an oxy-fuel combustor system, a second heat exchanger to transfer heat from a first discharge stream of a first uncooled compressor of the oxy-fuel combustor system to the regen gas stream, or a third heat exchanger to transfer heat from a second discharge stream of a second uncooled compressor of the O₂ production system to the regen gas stream.

In some examples, the regen gas stream includes nitrogen.

In some examples, the O₂ production system includes a low-pressure column to produce the regen gas stream.

In some examples, the regen gas stream includes a waste nitrogen gas stream.

In some examples, the system further includes an adsorber unit and piping to pass the first portion of the first cryogenic fluid stream from the first cryogenic column to the adsorber unit, the first portion of the first cryogenic fluid stream cooling the adsorber unit to an operating temperature.

In some examples, the O₂ production system further produces a regen gas stream. The system further may include a heater to heat the regen gas stream. The N₂ rejection system may include an adsorber unit through which the heated regen gas stream passes to regenerate the adsorber unit by heating the adsorber unit and by stripping water from the adsorber unit.

In some examples, the heater heats the regen gas stream using heat generated through combustion, heat generated by electric energy, a first heat exchanger to transfer heat from a turbine exhaust stream to the regen gas stream, the turbine exhaust stream produced in an oxy-fuel combustor system, a second heat exchanger to transfer heat from a first discharge stream of a first uncooled compressor of the oxy-fuel combustor system to the regen gas stream, or a third heat exchanger to transfer heat from a second discharge stream of a second uncooled compressor of the O₂ production system to the regen gas stream.

In some examples, the regen gas stream includes nitrogen.

In some examples, the O₂ production system includes a low-pressure column to produce the regen gas stream.

In some examples, the regen gas stream includes a waste nitrogen gas stream.

In some examples, the system further includes an adsorber unit and piping to pass the second portion of the first cryogenic fluid stream from the second cryogenic column to the adsorber unit, the second portion of the first cryogenic fluid stream cooling the adsorber unit to an operating temperature.

In some examples, the disclosure provides a method for processing gases. A first cryogenic fluid stream is cryogenically separated from an air stream through an O₂ production system. A first cryogenic column in a CO₂ production system transfers heat to a first portion of the first cryogenic fluid stream. The CO₂ production system separates carbon dioxide from a combustion product stream. A second cryogenic column in an N₂ rejection system transfers heat to a second portion of the first cryogenic fluid stream. The N₂ rejection system separates a second cryogenic fluid stream from a combustible carbonaceous gas fuel stream. The air stream transfers heat to a first portion of the second cryogenic fluid stream.

In some examples, the method includes combusting a carbonaceous gas stream in an oxy-fuel combustor in a power plant with a purified O₂ stream produced by the O₂ production system from the ambient air stream, producing a transcritical CO₂ working fluid for driving a turbine.

In some examples, the method includes enhancing efficiency of an oxy-fuel power cycle combusting a purified natural gas stream with a purified O₂ stream in the presence of a recycle carbon dioxide working fluid stream to form the combustion product stream.

In some examples, the method includes transferring heat from the first cryogenic column to a second portion of the second cryogenic fluid stream.

In some examples, the method includes passing the second portion of the second cryogenic fluid stream from the first cryogenic column to an adsorber in the N₂ rejection system, cooling the adsorber to an operating temperature.

In some examples, the first cryogenic fluid stream is selected from the group consisting of nitrogen, oxygen, argon, helium, and carbon dioxide. In some examples, the second cryogenic fluid stream is selected from the group consisting of natural gas, methane, nitrogen, carbon dioxide, light hydrocarbons, and argon.

In some examples, the first cryogenic fluid stream is nitrogen, and the O₂ production system further produces a third cryogenic fluid stream including O₂.

In some examples, the method includes an oxy-fuel combustor system producing the combustion product stream by combusting a purified natural gas stream from the N₂ rejection system with an oxygen gas stream from the O₂ production system with a recycle carbon dioxide working stream from the oxy-fuel combustor system.

In some examples, the combustible carbonaceous gas fuel stream is selected from the group consisting of natural gas, methane, synthetic gas, gasified coal, gasified biomass, and other light hydrocarbons.

In some examples, the method includes transferring heat from the air stream to at least a first portion of the second cryogenic fluid stream using a direct contact water chiller.

In some examples, the method includes transferring heat from the air stream to at least a first portion of the second cryogenic fluid stream using a heat exchanger.

In some examples, the method includes transferring heat from the air stream to a third portion of the first cryogenic fluid stream.

In some examples, the method includes producing a regen gas stream in the O₂ production system, heating the regen gas stream in a heater, and passing the regen gas stream through an adsorber in the CO₂ production system. The regen gas stream regenerates the adsorber by heating the adsorber and by stripping water from the adsorber.

In some examples, the method includes heating the regen gas stream by combustion, electric energy, transferring heat from a turbine exhaust stream to the regen stream, the turbine exhaust stream produced in an oxy-fuel combustor system, or transferring heat from a discharge stream of an uncooled compressor to the regen stream, the uncooled compressor including a compressor in the O₂ production system, a compressor in an oxy-fuel combustor system, or both.

In some examples, the regen gas stream includes nitrogen.

In some examples, the regen gas stream is produced by a low-pressure column in the O₂ production system.

In some examples, the regen gas stream includes a waste nitrogen gas stream.

In some examples, the method includes passing the first portion of the first cryogenic fluid stream from the first cryogenic column to the adsorber, cooling the adsorber to an operating temperature.

In some examples, the method includes producing a regen gas stream in the O₂ production system, heating the regen gas stream in a heater, and passing the regen gas stream through an adsorber in the N₂ rejection system. The regen gas stream regenerates the adsorber by heating the adsorber and by stripping water from the adsorber.

In some examples, the method includes heating the regen stream by combustion, electric energy, transferring heat from a turbine exhaust stream to the regen stream, the turbine exhaust stream produced in an oxy-fuel combustor system, transferring heat from a discharge stream of an uncooled compressor to the regen stream, the uncooled compressor including a compressor in the O₂ production system, a compressor in an oxy-fuel combustor system, or both.

In some examples, the regen gas stream includes nitrogen.

In some examples, the regen gas stream is produced by a low-pressure column in the O₂ production system.

In some examples, the regen gas stream includes a waste nitrogen gas stream.

In some examples, the method includes passing the second portion of the first cryogenic fluid stream from the second cryogenic column to the adsorber after the adsorber regenerates, cooling the adsorber to an operating temperature.

Further examples are provided in the drawings, detailed description, and claims.

### BRIEF DESCRIPTION OF DRAWINGS

The following drawings are provided to illustrate certain examples described herein. The drawings are merely illustrative and are not intended to limit the scope of the present disclosure or the present claims, and are not intended to show every potential feature or embodiment of the present disclosure or the present claims. The drawings are not necessarily drawn to scale; in some instances, certain elements of the drawing may be enlarged with respect to other elements of the drawing for purposes of illustration.

FIG. 1 is a process flow diagram showing an example system for processing gases.

FIG. 2 is a block diagram showing an example method for processing gases.

FIG. 3 is a block diagram showing an example method for processing gases.

FIG. 4 is a block diagram showing an example method for processing gases.

FIG. 5 is a block diagram showing an example method for processing gases.

### DETAILED DESCRIPTION

The following description recites various example systems and methods disclosed herein. No particular example is intended to define the scope of the present systems and methods. Rather, the examples provide non-limiting examples of various systems, and methods, that are included within the scope of the present disclosure and the present claims. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” “illustratively,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed example.

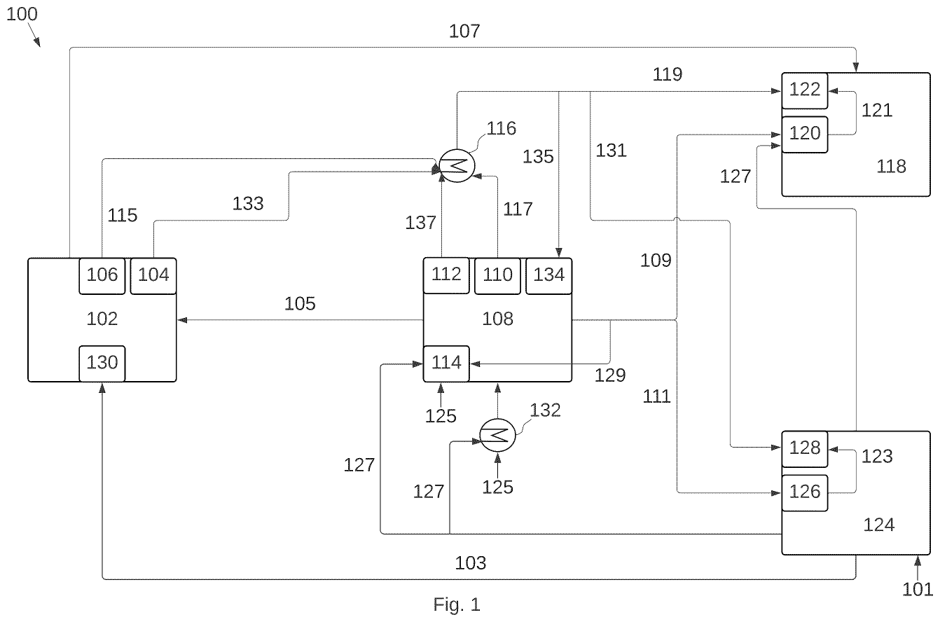

Now referring to FIG. 1, FIG. 1 is a process flow diagram showing an example system 100 for processing gases that may be used in some examples provided herein. This example is purely illustrative, and multiple other examples are envisioned or may be readily envisioned without undue experimentation.

In some examples, system 100 includes an oxy-fuel power plant 102, which in some regards may be similar to the one described in U.S. Pat. No. 8,596,075. For example, oxy-fuel power plant 102 may be configured to receive a fuel stream 103 and to combust the fuel stream in an oxy-fuel combustor 130 with a mixture of oxygen stream 105 and a recycled carbon dioxide (CO₂) stream 133 from the oxy-fuel power plant 102 for temperature control. Stream 133 gives its heat to stream 117 (described in further detail below) and returns to the oxy-fuel power plant for further use in the oxy-fuel combustion cycle. In some embodiments, the fuel stream (which also may be referred to as a combustible carbonaceous gas fuel stream) may be selected from the group consisting of natural gas, methane, synthetic gas, gasified coal, gasified biomass, and other light hydrocarbons. In some examples, the recycled CO₂ stream is, consists essentially of, or includes a transcritical working fluid that drives a turbine 106. Example components of the oxy-fuel power plant 102 of relevance to the non-limiting example illustrated in FIG. 1 include an oxy-fuel compression train 104 and turbine 106. In one example, the oxy-fuel compression train 104 compresses recycle carbon dioxide from 4 MPa to 32 MPa to be recycled back to the combustion chamber 130. Low heat can be extracted from the compression train 104 when the compression train does not have intercooling, as in one example shown herein. The turbine 106 produces a hot turbine exhaust gas stream 115. In examples shown below, the turbine exhaust gas stream 115 is intercepted and sent to give heat to other streams, and then is redirected back into the oxy-fuel plant 102 for normal exhaust processing.

In examples such as illustrated in FIG. 1, system 100 may include an O₂ production system 108, such as a modified air separation unit. O₂ production system 108 is configured to produce oxygen 105 and first cryogenic fluid streams 109, 111, and/or 129, from an air stream 125 (e.g., air at ambient conditions, meaning drawn from outside without further treatment other than that described herein). In some examples, the first cryogenic fluid stream (e.g., 109, 111, and/or 129) is selected from the group consisting of nitrogen, oxygen, argon, helium, and carbon dioxide. Optionally, O₂ production system 108 further is configured to produce, or use, one or more various other streams in a manner such as described herein. In examples such as illustrated in FIG. 1, the O₂ production system 108 includes a low-pressure column 110, a compression train 112, and a chiller 114, such as a direct contact water chiller. The first cryogenic fluid streams 109 and 111 are used in many examples provided herein, while stream 129 optionally is used in some examples.

The low-pressure column 110 is a cryogenic column used to separate pure oxygen from low purity nitrogen. The compression train 112 is configured to compress air and then expand the compressed air through a Joule-Thomson valve or a turbine to drop pressure before sending the air to the low-pressure column 110. The chiller 114 is used to remove water from the air stream.

The O₂ production system 108 may be configured to use the low-pressure column 110, compression train 112, and chiller 114 to produce cryogenic oxygen and cryogenic nitrogen. As such, the first cryogenic fluid streams 109, 111, and 129 independently may be, may consist essentially of, or may include either oxygen or nitrogen, or a mixture of oxygen and nitrogen. In some examples, the first cryogenic fluid stream is nitrogen while the O₂ production system further produces a third cryogenic fluid stream of oxygen.

In nonlimiting examples in which one or more of the first cryogenic fluid streams 109, 111, and 129 are, consist essentially of, or include oxygen, after the ‘cold energy’ is removed from such stream(s) (e.g., by such stream(s) being heated by the other streams that such stream(s) contact), the stream(s) are sent on as oxygen stream 105 to the oxy-fuel combustion plant 102 or to other suitable system or process. In nonlimiting examples in which one or more of the first cryogenic fluid streams 109, 111, and 129 are nitrogen, after the ‘cold energy’ is removed from such stream(s) (e.g., by such stream(s) being heated by the other streams that such stream(s) contact), the stream(s) may be used to regenerate adsorbers, e.g., adsorber units 122 and/or 128, e.g., in a manner such as discussed below.

In this and other examples, piping carries the various fluid streams between system components and/or unit operations. Piping is a standard means of transporting fluid between system components and/or unit operations. Suitable piping may be selected for different applications based upon fluid properties and configured to move the fluids as desired.

As illustrated in FIG. 1, system 100 may include CO₂ production system 118, such as a modified carbon dioxide purification unit. CO₂ production system may be configured to produce purified CO₂ from a CO₂ feed stream 107, and optionally may use or produce various streams in a manner such as described herein. CO₂ feed stream 107 may be, may consist essentially of, or may include the final, pressurized output of the oxy-fuel plant 102, and may act as the feedstock for CO₂ production system 118. In some examples, stream 115 is upstream of stream 107, and stream 133 is between streams 115 and 107. In examples such as illustrated in FIG. 1, the CO₂ production system 118 includes a cryogenic column 120 and an adsorber unit 122. In the CO₂ production system 118, the adsorber unit 122 is used to remove water from the CO₂ feed stream 107. Adsorber units in the N₂ rejection system and the O₂ production system are similarly configured to remove water from their respective feed streams.

As illustrated in FIG. 1, system 100 also may include nitrogen (N₂) rejection system 124, such as a modified nitrogen rejection unit. N₂ rejection system 124 may be configured to remove N₂ from a combustible carbonaceous fuel stream 101, such as raw natural gas, to produce a combustion gas 103 (e.g., a fuel stream which may be provided to oxy-fuel power plant 102 or to other suitable system or process). N₂ rejection system 124 may use or produce one or more various other streams, e.g., in a manner such as described herein. In some examples, the N₂ rejection system 124 may include one or more cryogenic columns 126 (a single such cryogenic column 126 being illustrated in FIG. 1) and an adsorber unit 128. The cryogenic column(s) are configured to purify natural gas, or other suitable combustion gas, by removing nitrogen and other contaminants from the feed stream. The adsorber unit 128 removes water before the cryogenic column(s) 126 to inhibit or prevent ice buildup in the cryogenic column(s) 126. The N₂ rejection system 124 may be configured to use the cryogenic column(s) 126 and adsorber unit 128 to produce any suitable number of cryogenic fluid streams, dependent on the combustible carbonaceous fuel stream 101 provided as input to the N₂ rejection system 124.

In the nonlimiting example illustrated in FIG. 1, the product streams provided as output from N₂ rejection system 124 include natural gas and nitrogen as separate streams. In some embodiments, the second cryogenic fluid stream 127 is selected from the group consisting of natural gas, methane, nitrogen, carbon dioxide, light hydrocarbons, and argon. In some nonlimiting examples, second cryogenic fluid stream 127, which may be utilized in a manner such as described below, may be, may consist essentially of, or may include natural gas. As illustrated in FIG. 1, stream 127 may be warmed as described herein. In examples in which stream 127 is natural gas, stream 127 may in some examples be, consist essentially of, or include a slipstream from stream 103; the heat may be taken from such slipstream in a manner such as described herein, and the slipstream then returned to rejoin fuel stream 103 to be sent to the oxy-fuel plant 102, or to other suitable system or process. In nonlimiting examples in which second cryogenic fluid stream 127 is, consists essentially of, or includes nitrogen, stream 127 may be used for direct contact or indirect contact heat exchange with another stream (e.g., within water chiller 114 of O₂ production system 108 cryogenic column 120 of CO₂ production system 118, and/or air stream 125). In some examples the resultant warmed nitrogen from such heat exchange(s) may be disposed of, stored, or otherwise used in a suitable system or process, depending on the facilities chosen in the final design.

In the example illustrated in FIG. 1, the O₂ production system 108 receives the air stream 125 (e.g., ambient air stream). In some examples, the air stream optionally may be pre-cooled using a second cryogenic fluid stream 127 (e.g., nitrogen or natural gas) from the N₂ rejection system 124. In some examples, this pre-cooling is performed using an indirect-contact heat exchanger 132 in which the air 125 passes heat to the second cryogenic fluid stream 127. Additionally, or alternatively, in some examples, this pre-cooling is performed by cooling the chiller 114 using the second cryogenic fluid stream 127, and the air stream 125 being cooled by the chiller 114. Additionally, or alternatively, in nonlimiting examples where stream 127 is, consists essentially of, or includes nitrogen or other gas which normally occurs in air and is suitable to enter and be processed by O₂ production system 108, the air stream 125 may be cooled by direct contact with second cryogenic fluid stream 127. Additionally, or alternatively, in some examples, a portion of the first cryogenic fluid stream 129 from O₂ production system 108 is recycled from the O₂ production system 108 to the chiller 114 to pre-cool the air stream 125. Additionally, or alternatively, in some examples in which stream 129 is, consists essentially of, or includes cryogenic O₂, once the pre-cooling is complete, stream 129 may be passed on to power plant 102 (or other suitable system or process) as oxygen stream 105. Additionally, or alternatively, in nonlimiting examples in which stream 129 is, consists essentially of, or includes N₂ or other gas, the N₂ or other gas can be directed to storage as a product, or can be vented to the atmosphere, or used in any other suitable system or process. Although FIG. 1 illustrates both chiller 114 and heat exchanger 132, it will be appreciated that some examples may omit chiller 114, or may omit heat exchanger 132, or may omit both chiller 114 and heat exchanger 132. That is, air stream 125 may be precooled in some examples, and may not be precooled in other examples.

In the nonlimiting example illustrated in FIG. 1, the O₂ production system 108 is configured to produce a purified O₂ stream and one or more N₂ streams, all of which may be at cryogenic temperatures and may be used to provide cold power for other cryogenic components within system 100. For example, as recognized by the present inventors, the O₂ production system 108 can be sized and configured to provide sufficient cooling for both the CO₂ production system 118 and the N₂ rejection system 124, thus eliminating the need for either of those systems to have their own cryogenic plants to provide their own cooling. A cryogenic plant refers to a unit operation that produces cryogenic fluids, such as the O₂ production system 108. Illustratively, CO₂ production system 118 may not include its own cryogenic plant, and cryogenic column 120 may be cooled solely using first cryogenic stream 129 from O₂ production system 108 and/or using second cryogenic stream 127 from N₂ rejection system 124. Additionally, or alternatively, N₂ rejection system 124 may not include its own cryogenic plant, and cryogenic column(s) 126 may be cooled solely using first cryogenic stream 129 from O₂ production system 108. As recognized by the present inventors, providing all, substantially all, or a significant portion of the cooling using a single cryogenic plant (e.g., the O₂ production system 118, which is a standalone cryogenic plant) saves on capital expenses, as well as operating expenses. For example, because a single larger cryogenic plant may be more efficient to build and operate than multiple smaller cryogenic plants.

As noted above, O₂ production system 108 may produce a cryogenic oxygen stream and a cryogenic nitrogen stream. Each of these streams can act as any suitable one or ones of the first cryogenic fluid streams 109, 111, and 129 and may be used to significantly enhance efficiency of system 100.

Illustratively, in some examples, a first portion of the first cryogenic fluid stream (cryogenic fluid stream 109) is passed to the CO₂ production system 118 where heat from the cryogenic column 120 is transferred into the cryogenic fluid stream 109, thereby providing at least some of the cooling for cryogenic column 120. In some examples, cryogenic fluid stream 109 provides all of the cooling for cryogenic column 120. In nonlimiting examples in which the cryogenic fluid stream 109 is, consists essentially of, or includes nitrogen, the cryogenic fluid stream 109 may be warmed by cryogenic column 120 to become a warm fluid stream 121 that optionally may be utilized in adsorption control, in a manner such as described herein.

Additionally, or alternatively, in some examples a second portion of the first cryogenic fluid stream (cryogenic fluid stream 111) is passed to the N₂ rejection system 124 where heat from one or more cryogenic columns 126 is transferred into the cryogenic fluid stream 111, thereby providing at least some of the cooling for the one or more cryogenic columns 126. In some examples, cryogenic fluid stream 111 provides all of the cooling for the one or more cryogenic columns 126. In nonlimiting examples in which the cryogenic fluid stream 111 is, consists essentially of, or includes nitrogen, the cryogenic fluid stream 111 is warmed by cryogenic column(s) 126 to become a warm fluid stream 123 that optionally may be utilized in adsorption control, e.g., in a manner such as described below.

In some examples, the O₂ production system 108 produces a waste nitrogen stream 117 from the low-pressure column 110. In some examples, this nitrogen gas stream 117 can be heated and then utilized to regenerate one or more adsorbers as a hot regen gas stream 119, 131, and/or 135. In some examples, nitrogen gas stream is heated to form one or more of the hot regen gas streams 119, 131, and/or 135, each of which may be at a temperature in the range of about 200° C. to about 300° C., e.g., about 250° C. In the nonlimiting example illustrated in FIG. 1, the heat to warm nitrogen gas stream 117 is supplied by using indirect contact heat exchanger 116 to transfer heat from uncooled compressor discharge 137 from compressor train 112 of O₂ production system 108 to gas stream 117. Stream 137 returns back to the compressor train 112, though this is not shown. As illustrated in FIG. 1, heat exchanger 116 may heat gas stream 117 to form regen gas streams 119, 131, and/or 135. Note that there can be more than one compressor train 112 in the O₂ production system 108, and so the heat could be from a single compressor train or multiple. Additionally, or alternatively, in some examples the heat to warm gas stream 117 is supplied by using indirect contact heat exchanger 116 to transfer heat from uncooled compressor discharge 133 in compressor train 104 of power plant 102 in a manner such as illustrated in FIG. 1. Additionally, or alternatively, in some examples the heat to warm gas stream 117 is supplied by using indirect contact heat exchanger 116 to transfer heat from a hot turbine exhaust stream 115 of power plant 102 in a manner such as illustrated in FIG. 1.

Heated gas stream 117 may be used in any suitable manner(s). Illustratively, the O₂ production system 108 may include a purifier 134. The purifier 134 is configured to remove CO₂ from the product stream. In examples such as illustrated in FIG. 1, the purifier 134 can be heated by hot regen stream 135 which is formed by warming gas stream 117. Additionally, or alternatively, hot regen gas stream 119 (formed by warming gas stream 117) may be passed through adsorber unit 122 of CO₂ production system 118, thus heating the adsorber unit 122 and stripping water from the adsorber unit 122, thereby regenerating the adsorber unit 122. In one nonlimiting example, after stripping is complete, warm fluid stream 121 (which may be formed by transferring heat from cryogenic column 120 to cryogenic fluid stream 109 and which may be, may consist essentially of, or may include nitrogen) is passed into the adsorber unit 122. The warm fluid stream 121 may be cooler than the operating temperature of the adsorber unit 122. That is, the warm fluid stream 121 may be referred to as “warm” because it is warmer than first cryogenic fluid stream 109. The warm fluid stream 121 may be used to cool the adsorber unit 122 down to the desired operating temperature of the adsorber unit 122.

Additionally, or alternatively, hot regen gas stream 131 (formed by warming gas stream 117) may be passed through adsorber unit 128 of N₂ rejection system, thus heating the adsorber unit 128 and stripping water from the adsorber unit 128, thereby regenerating the adsorber unit 128. In one nonlimiting example, after stripping is complete, warm fluid stream 123 (which may be formed by warming cryogenic fluid stream 111 using cryogenic column(s) 126, and which may be, consist essentially of, or include nitrogen) is passed into the adsorber unit 128. The warm fluid stream 123 may be cooler than the operating temperature of the adsorber unit 128. That is, the warm fluid stream 123 may be referred to as “warm” because it is warmer than first cryogenic fluid stream 111. The warm fluid stream 123 may be used to cool the adsorber unit 128 down to the desired operating temperature of the adsorber unit 128. It will be appreciated that in other examples, warm fluid stream 123 instead may be used to cool adsorber unit 122; that warm fluid stream 121 instead may be used to cool adsorber unit 128; that such cooling is optional; and that fluid streams 121 and 123 may be used in any other suitable system or process, or may be discarded.

It will further be appreciated that the present systems and methods may be adapted for use with any other suitable power plant configuration, and indeed with any other type of system. Put another way, oxy-fuel power plant 102 may be considered to be an optional component of system 100, and may be omitted or may be replaced with any other suitable power plant or other system. The various gas streams from O₂ production system 108, CO₂ production system 118, and N₂ rejection system 124 may be used in any suitable system(s) or process(es) while still retaining the benefits described herein, such as enhancing efficiency and reducing the number of cryogenic plants needed to process gases.

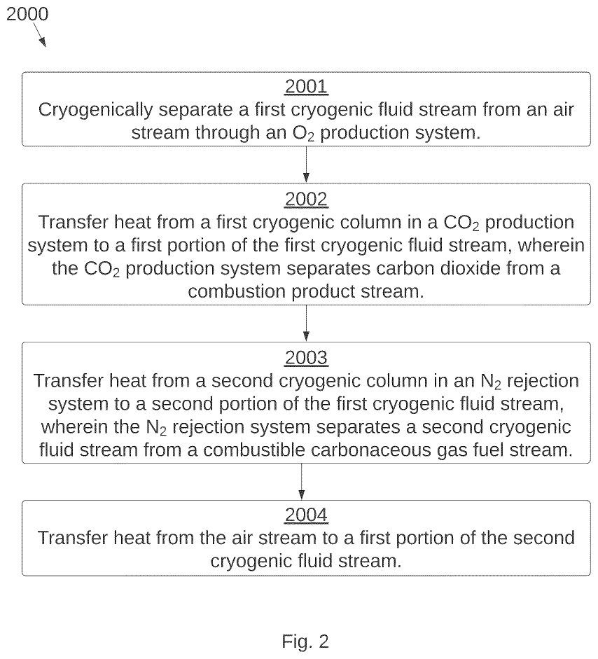

Illustratively, FIG. 2 is a block diagram showing an example method 2000 for processing gases that may be used in some examples provided herein. Method 2000 may include cryogenically separating a first cryogenic fluid stream from an air stream through an O₂ production system (operation 2001). For example, in a manner such as described with reference to FIG. 1, O₂ production system 108 may separate first cryogenic fluid stream(s) 109, 111, 129 from air stream 125. Method 2000 illustrated in FIG. 2 also may include transferring heat from a first cryogenic column in a CO₂ production system to a first portion of the first cryogenic fluid stream, wherein the CO₂ production system separates carbon dioxide from a combustion product stream (operation 2002). For example, in a manner such as described with reference to FIG. 1, CO₂ production system 118 may transfer heat from cryogenic column 120 to cryogenic fluid stream 109. Method 2000 illustrated in FIG. 2 also may include transferring heat from a second cryogenic column in an N₂ rejection system to a second portion of the first cryogenic fluid stream, wherein the N₂ rejection system separates a second cryogenic fluid stream from a combustible carbonaceous gas fuel stream (operation 2003). For example, in a manner such as described with reference to FIG. 1, N₂ rejection system 124 may transfer heat from cryogenic column(s) 126 to cryogenic fluid stream 111. As such, it may be understood that in operations 2001, 2002, and 2003 of method 2000, first cryogenic fluid(s) generated during O₂ production may be used to also cryogenically generate CO₂ and to separate N₂ from a carbonaceous gas fuel stream, thus providing significant efficiencies in capital equipment, energy usage, and in operating cost.

Method 2000 illustrated in FIG. 2 optionally also may include transferring heat from the air stream to a first portion of the second cryogenic fluid stream (operation 2004). For example, in a manner such as described with reference to FIG. 1, second cryogenic fluid stream 127 from N₂ rejection system 124 optionally may be used to directly and/or indirectly pre-cool air stream 125. As such, it may be understood that operation 2004 of method 2000 may reduce the amount of energy required to generate the first cryogenic fluid(s) that then are used to cryogenically generate CO₂ and to separate N₂ from a carbonaceous gas fuel stream, thus providing even further enhancements in energy savings, infrastructure, and the like.

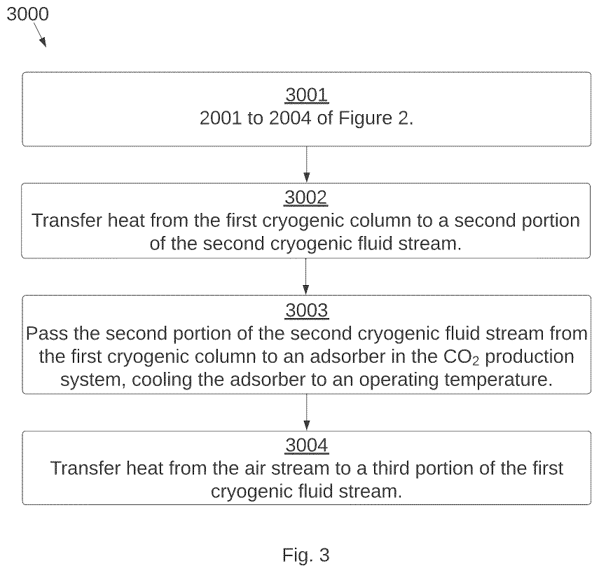

FIG. 3 is a block diagram showing an example method 3000 for processing gases that may be used in some examples provided herein. Method 3000 may include performing operations 2001 through 2004 of method 2000 described with reference to FIG. 2 (operation 3001). Method 3000 illustrated in FIG. 3 also may include transferring heat from the first cryogenic column to a second portion of the second cryogenic fluid stream (operation 3002). For example, in a manner such as described with reference to FIG. 1, heat from cryogenic column 120 of CO₂ production system 118 may be transferred to second cryogenic fluid stream 127 from N₂ rejection system 124. Method 3000 illustrated in FIG. 3 may include passing the second portion of the second cryogenic fluid stream from the first cryogenic column to an adsorber in the CO₂ production system, cooling the adsorber to an operating temperature (operation 3003). For example, in a manner such as described with reference to FIG. 1, after being warmed by first cryogenic column 120, second cryogenic fluid stream 127 may be passed as warm fluid stream 121 to adsorber unit 122 of CO₂ production system 118. Method 3000 illustrated in FIG. 3 optionally may include transferring heat from the air stream to a third portion of the first cryogenic fluid stream (operation 3004). For example, in a manner such as described with reference to FIG. 1, a portion of the first cryogenic fluid stream 129 from O₂ production system 108 optionally may be recycled from the O₂ production system 108 to the chiller 114 to pre-cool the air stream 125.

It will be appreciated that operations 3002, 3003, and 3004 may be performed independently of one another, and need not necessarily be performed as part of a common method. For example, operation 3002 may be performed without performing operations 3003 and/or 3004. Or, for example, operation 3003 may be performed without performing operations 3002 and/or 3004. Or, for example, operation 3004 may be performed without performing operations 3002 and/or 3003. Cooling the adsorber back down to operating temperature after it is regenerated, using another cold gas in the system for the cooling, can reduce or minimize cold energy usage and thus improve efficiency and lower operating costs.

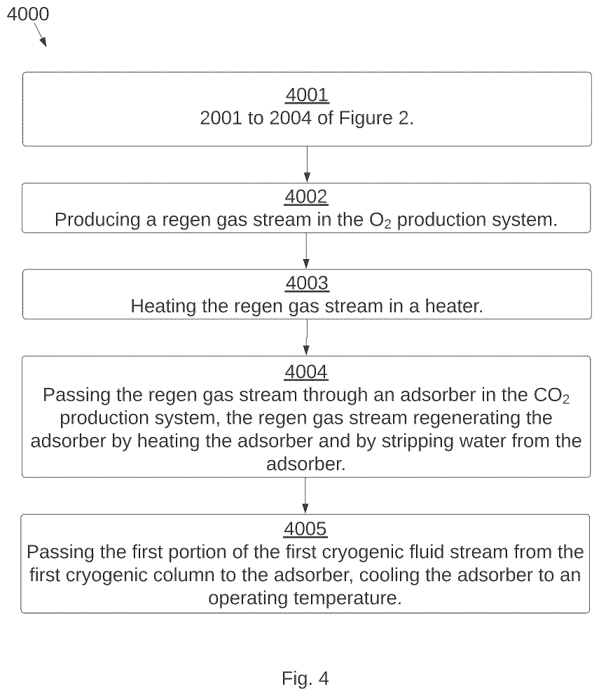

FIG. 4 is a block diagram showing an example method 4000 for processing gases that may be used in some examples provided herein. Method 4000 may include performing operations 2001 through 2004 of method 2000 described with reference to FIG. 2 (operation 4001). Method 4000 may include producing a regen gas stream in the O₂ production system (operation 4002). For example, in a manner such as described with reference to FIG. 1, 02 production system 108 may produce nitrogen gas stream 117, which in some examples is a waste nitrogen stream. Method 4000 illustrated in FIG. 4 may include heating the regen gas stream in a heater (operation 4003). For example, in a manner such as described with reference to FIG. 1, nitrogen gas stream 117 may be heated using heat exchanger 116 to form regen gas streams 119, 131, and/or 135. In various examples such as described above, the regen gas stream may be heated by combustion, by electric energy, by transferring heat from a turbine exhaust stream, and/or by transferring heat from a discharge stream of an uncooled compressor.

Method 4000 illustrated in FIG. 4 may include passing the regen gas stream through an adsorber in the CO₂ production system, the regen gas stream regenerating the adsorber by heating the adsorber and by stripping water from the adsorber (operation 4004). For example, in a manner such as described with reference to FIG. 1, regen gas stream 119 may be passed through adsorber unit 122 of CO₂ production system 118. Method 4000 illustrated in FIG. 4 optionally may include passing the first portion of the first cryogenic fluid stream from the first cryogenic column to the adsorber, cooling the adsorber to an operating temperature (operation 4005). For example, in a manner such as described with reference to FIG. 1, stream 121 optionally may passed from cryogenic column 120 of CO₂ production system 118 to adsorber unit 122 to cool the adsorber unit to an operating temperature after regen gas stream 119 is used to regenerate the adsorber unit.

It will be appreciated that operations described with reference to FIG. 4 may be performed independently of one another, and need not necessarily be performed as part of a common method. For example, operation 4005 may be performed without performing operations 4002-4004. Or, for example, operations 4002-4004 may be performed without performing operation 4005. Overall, by using a regen (e.g., waste nitrogen) stream, heating the regen stream with waste heat (rather than heating by combustion or electrical), and then using the regen stream to regenerate the adsorber, this process reduces or minimizes new reagent usage and new energy consumption. The operations use existing commodities, rather than requiring consumption of external inventory (heat and reagent). Heating the adsorber by combustion or electrical is less economical than using waste heat. Further, cooling the adsorber back down to operating temperature after it is regenerated, using another cold gas in the system for the cooling, can reduce or minimize cold energy usage and thus improve efficiency and lower operating costs.

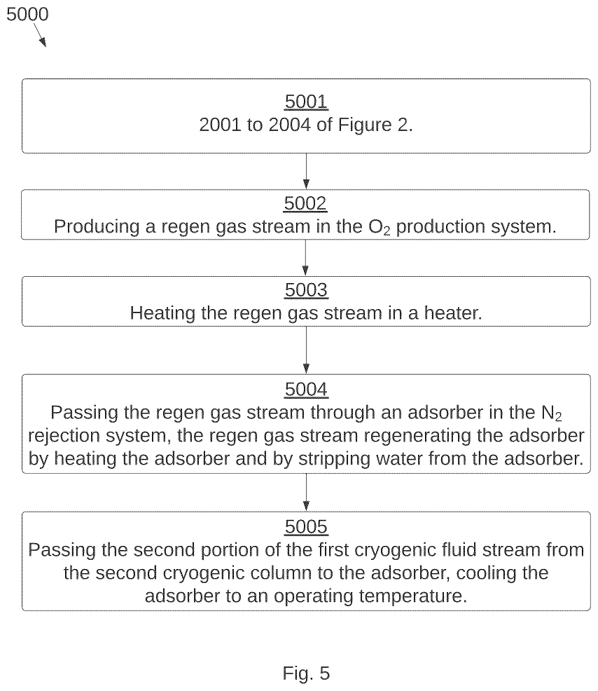

FIG. 5 is a block diagram showing an example method for processing gases that may be used in some examples provided herein. Method 5000 may include performing operations 2001 through 2004 of method 2000 described with reference to FIG. 2 (operation 5001). Method 5000 may include producing a regen gas stream in the O₂ production system (operation 5002). For example, in a manner such as described with reference to FIG. 1, O₂ production system 108 may produce nitrogen gas stream 117, which in some examples may be a waste nitrogen stream. Method 5000 illustrated in FIG. 5 may include heating the regen gas stream in a heater (operation 5003). For example, in a manner such as described with reference to FIG. 1, nitrogen gas stream 117 may be heated using heat exchanger 116 to form regen gas streams 119, 131, and/or 135. In various examples such as described above, the regen gas stream may be heated by combustion, by electric energy, by transferring heat from a turbine exhaust stream, and/or by transferring heat from a discharge stream of an uncooled compressor. Method 5000 illustrated in FIG. 5 may include passing the regen gas stream through an adsorber in the N₂ rejection system, the regen gas stream regenerating the adsorber by heating the adsorber and by stripping water from the adsorber (operation 5004). For example, in a manner such as described with reference to FIG. 1, regen gas stream 131 may be passed through adsorber unit 128 of N₂ rejection system 124. Method 5000 illustrated in FIG. 5 also may include passing the second portion of the first cryogenic fluid stream from the second cryogenic column to the adsorber, cooling the adsorber to an operating temperature (operation 5005). For example, in a manner such as described with reference to FIG. 1, stream 124 may passed from cryogenic column(s) 126 of N₂ rejection system 124 to adsorber unit 128 to cool the adsorber unit to an operating temperature after regen gas stream 131 is used to regenerate the adsorber unit. It will be appreciated that operations described with reference to FIG. 5 may be performed independently of one another, and need not necessarily be performed as part of a common method. For example, operation 5005 may be performed without performing operations 5002-5004. Or, for example, operations 5002-5004 may be performed without performing operation 5005. Overall, by using a regen (e.g., waste nitrogen) stream, heating the regen stream with waste heat (rather than heating by combustion or electrical), and then using the regen stream to regenerate the adsorber, this process reduces or minimizes new reagent usage and new energy consumption. The operations use existing commodities, rather than requiring consumption of external inventory (heat and reagent). Heating the adsorber by combustion or electrical is less economical than using waste heat. Further, cooling the adsorber back down to operating temperature after it is regenerated, using another cold gas in the system for the cooling, can reduce or minimize cold energy usage and thus improve efficiency and lower operating costs.

A variety of different permutations of system 100 and of methods 2000, 3000, 4000, and 5000 readily may be implemented based on the present teachings.

Illustratively, in some examples, the present systems and methods may be used with a power plant that employs an oxy-fuel combustor 130 for driving a turbine using a mixture of a purified natural gas stream 103 produced by the N₂ rejection system 124 from the combustible carbonaceous gas fuel stream 101, with a purified O₂ stream 105 produced by the O₂ production system 108, and with a CO₂ working fluid, which is internal to oxy-fuel plant 102. The CO₂ working fluid is used in many example systems and methods. In certain examples provided herein, the CO₂ working fluid is used in a mixture with the oxygen 105 for combustion. For example, system 100 may include such a power plant, or may be used with such a power plant. Or, for example, method 2000, method 3000, method 4000, and/or method 5000 may be used in or with such a power plant.

Additionally, or alternatively, in some examples, the CO₂ working fluid may be transcritical and is, consists essentially of, or includes a recycle carbon dioxide working fluid stream 133, and an oxy-fuel combustor 130 generates the combustion product stream 115.

In some examples, the combustion product stream 115 is produced by an oxy-fuel combustor system 102 by combusting a purified natural gas stream 103 from the N₂ rejection system 124 with an oxygen gas stream 105 from the O₂ production system 108 with a recycle carbon dioxide working stream 133 from the oxy-fuel combustor system.

All patents and published patent applications referred to herein are incorporated herein by reference. The invention has been described with reference to various examples. Nevertheless, it is understood that many variations and modifications may be made while remaining within the spirit and scope of the invention.

What is claimed is:

1. A system for processing gases, comprising:
an O₂ production system to cryogenically separate a first cryogenic fluid stream from an air stream;
a CO₂ production system comprising a first cryogenic column to cryogenically separate carbon dioxide from a combustion product stream, the first cryogenic column heating a first portion of the first cryogenic fluid stream;
an N₂ rejection system comprising a second cryogenic column to cryogenically separate a second cryogenic fluid stream from a combustible carbonaceous gas fuel stream, the second cryogenic column heating a second portion of the first cryogenic fluid stream; and
the O₂ production system further being to cool the air stream using a first portion of the second cryogenic fluid stream.

2. The system of claim 1, further comprising a power plant that employs an oxy-fuel combustor for driving a turbine using a mixture of a purified natural gas stream produced by the N₂ rejection system from the combustible carbonaceous gas fuel stream, a purified O₂ stream produced by the O₂ production system, and a CO₂ working fluid,
wherein the CO₂ working fluid is transcritical and comprises a recycle carbon dioxide working fluid stream, and wherein an oxy-fuel combustor generates the combustion product stream.

3-6. (canceled)

7. The system of claim 1, wherein the first cryogenic fluid stream is nitrogen and wherein the O₂ production system further produces a third cryogenic fluid stream comprising oxygen.

8. The system of claim 7, wherein the combustion product stream is produced by an oxy-fuel combustor system by combusting a purified natural gas stream from the N₂ rejection system with an oxygen gas stream from the O₂ production system with a recycle carbon dioxide working stream from the oxy-fuel combustor system.

9-25. (canceled)

26. A method for processing gases, comprising:
cryogenically separating a first cryogenic fluid stream from an air stream through an O₂ production system;
transferring heat from a first cryogenic column in a CO₂ production system to a first portion of the first cryogenic fluid stream, wherein the CO₂ production system separates carbon dioxide from a combustion product stream;
transferring heat from a second cryogenic column in an N₂ rejection system to a second portion of the first cryogenic fluid stream, wherein the N₂ rejection system separates a second cryogenic fluid stream from a combustible carbonaceous gas fuel stream; and
transferring heat from the air stream to a first portion of the second cryogenic fluid stream.

27. The method of claim 26, further comprising combusting a carbonaceous gas stream in an oxy-fuel combustor in a power plant with a purified O₂ stream produced by the O₂ production system from the ambient air stream, producing a transcritical CO₂ working fluid for driving a turbine.

28. The method of claim 27, further comprising enhancing efficiency of an oxy-fuel power cycle combusting a purified natural gas stream with a purified O₂ stream in the presence of a recycle carbon dioxide working fluid stream to form the combustion product stream.

29. The method of claim 26, further comprising transferring heat from the first cryogenic column to a second portion of the second cryogenic fluid stream.

30. The method of claim 26, further comprising passing the second portion of the second cryogenic fluid stream from the first cryogenic column to an adsorber in the CO₂ production system, cooling the adsorber to an operating temperature.

31. The method of claim 26, wherein the first cryogenic fluid stream is selected from the group consisting of nitrogen, oxygen, argon, helium, and carbon dioxide, and wherein the second cryogenic fluid stream is selected from the group consisting of natural gas, methane, nitrogen, carbon dioxide, light hydrocarbons, and argon.

32. The method of claim 26, wherein the first cryogenic fluid stream is nitrogen and wherein the O₂ production system further produces a third cryogenic fluid stream comprising O₂.

33. The method of claim 26, further comprising an oxy-fuel combustor system producing the combustion product stream by combusting a purified natural gas stream from the N₂ rejection system with an oxygen gas stream from the O₂ production system with a recycle carbon dioxide working stream from the oxy-fuel combustor system.

34. The method of claim 26, wherein the combustible carbonaceous gas fuel stream is selected from the group consisting of natural gas, methane, synthetic gas, gasified coal, gasified biomass, and other light hydrocarbons.

35. The method of claim 26, wherein transferring heat from the air stream to at least a first portion of the second cryogenic fluid stream uses a direct contact water chiller.

36. The method of claim 26, wherein transferring heat from the air stream to at least a first portion of the second cryogenic fluid stream uses a heat exchanger.

37. The method of claim 26, further comprising transferring heat from the air stream to a third portion of the first cryogenic fluid stream.

38. The method of claim 26, further comprising:
producing a regen gas stream in the O₂ production system;
heating the regen gas stream in a heater;
passing the regen gas stream through an adsorber in the CO₂ production system, the regen gas stream regenerating the adsorber by heating the adsorber and by stripping water from the adsorber.

39. The method of claim 38, further comprising heating the regen gas stream by:
combustion;
electric energy;
transferring heat from a turbine exhaust stream to the regen stream, the turbine exhaust stream produced in an oxy-fuel combustor system; or
transferring heat from a discharge stream of an uncooled compressor to the regen stream, the uncooled compressor comprising a compressor in the O₂ production system, a compressor in an oxy-fuel combustor system, or both.

40. The method of claim 38, wherein the regen gas stream comprises nitrogen.

41. The method of claim 38, wherein the regen gas stream is produced by a low-pressure column in the O₂ production system.

42. The method of claim 38, wherein the regen gas stream comprises a waste nitrogen gas stream.

43. The method of claim 38, further comprising passing the first portion of the first cryogenic fluid stream from the first cryogenic column to the adsorber, cooling the adsorber to an operating temperature.

44. The method of claim 26, further comprising:
producing a regen gas stream in the O₂ production system;
heating the regen gas stream in a heater;
passing the regen gas stream through an adsorber in the N₂ rejection system, the regen gas stream regenerating the adsorber by heating the adsorber and by stripping water from the adsorber.

45. The method of claim 44, further comprising heating the regen stream by:
combustion;
electric energy;
transferring heat from a turbine exhaust stream to the regen stream, the turbine exhaust stream produced in an oxy-fuel combustor system; or transferring heat from a discharge stream of an uncooled compressor to the regen stream, the uncooled compressor comprising a compressor in the O₂ production system, a compressor in an oxy-fuel combustor system, or both.

46. The method of claim 44, wherein the regen gas stream comprises nitrogen.

47. The method of claim 44, wherein the regen gas stream is produced by a low-pressure column in the O₂ production system.

48. The method of claim 44, wherein the regen gas stream comprises a waste nitrogen gas stream.

49. The method of claim 44, further comprising passing the second portion of the first cryogenic fluid stream from the second cryogenic column to the adsorber after the adsorber regenerates, cooling the adsorber to an operating temperature.
